(19) United States
(12) Patent Application Publication
(10) Pub. No.: US 2026/0225496 A1
(43) Pub. Date: Aug. 6, 2026

(54) CONTROL SYSTEM FOR FUEL CELL WATERCRAFT

(71) Applicant: SUZUKI MOTOR CORPORATION, Hamamatsu-shi (JP)

(72) Inventors: Hideyuki SHISHITANI, Hamamatsu-shi (JP); Yoshifumi TAKAI, Hamamatsu-shi (JP)

(73) Assignee: SUZUKI MOTOR CORPORATION, Hamamatsu-shi (JP)

(21) Appl. No.: 19/393,050

(22) Filed: Nov. 18, 2025

(30) Foreign Application Priority Data
Feb. 3, 2025 (JP) 2025-016047

(51) Int. Cl. B60L 58/33; B60L 50/75; B63H 21/17; B63J 2/12; H01M 8/04029; H01M 8/04302; H01M 8/04701; H01M 8/04746

(52) U.S. Cl. CPC B60L 58/33; B60L 50/75; B63H 21/17; B63J 2/12; H01M 8/04029; H01M 8/04302; H01M 8/04723; H01M 8/04768; B60L 2200/32; H01M 2250/20

(57) ABSTRACT

There is provided a control system for a fuel cell watercraft without the need for a heater for low-temperature start-up or a switching valve to a bypass channel. In the control system for a fuel cell watercraft, the fuel cell watercraft includes: a seawater line and a seawater pump for taking in seawater from outside of the hull; a coolant line and a coolant pump for circulation of coolant between a heat exchanger on the seawater line and a fuel cell module; a battery adapted to be charged with electric power generated by the fuel cell module and to supply the electric power to the electric motor and the fuel cell module auxiliaries including the seawater pump and the coolant pump. The control system is configured to execute a start-up routine including starting the seawater pump and the coolant pump at a time of start-up, stopping the seawater pump and starting the fuel cell module when coolant temperature reaches seawater temperature or more, and restarting the seawater pump when the coolant temperature reaches steady-state operating temperature of the fuel cell module.

### CROSS-REFERENCE TO RELATED APPLICATION

This Application claims priority from Japanese Patent Application No. 2025-016047 filed Feb. 3, 2025, which is incorporated herein by reference in its entirety.

### FIELD

The present invention relates to control systems for fuel cell watercraft.

### BACKGROUND

Fuel cells are power generators that generate electric power through an oxidation-reduction reaction between hydrogen fuel and oxygen in the air. During power generation, heat and product water are generated. A polymer electrolyte fuel cell (PEFC), which uses a polymer electrolyte membrane as an electrolyte, needs to maintain its operating temperature at 80° C. or less. The PEFC therefore requires a cooling system for temperature regulation.

In addition, when a device is stopped, the product water remains on the surface of a membrane electrode assembly (MEA) in a fuel cell module. Accordingly, when the fuel cell module is stored at temperatures below freezing temperature, the remaining product water freezes, which hinders normal flow of hydrogen and air during a next start-up and causes a failure of power generation. JP 2007-280827 discloses a configuration in which a heater mounted to a cooling line is used to heat the fuel cell module and a configuration for switching to a bypass channel that bypasses a cooling radiator at the time of heating the fuel cell module.

[Prior Art] Jp 2007-280827

However, a system relying on a heater to perform low-temperature start-up consumed more electric power for heating with the heater and also required a bypass channel and a switching valve to the bypass channel, causing complication of the system.

The present invention has been made in view of the above problems of the conventional technology, and an object of the present invention is to provide a control system for fuel cell watercraft without the need for a heater for cold starting or a switching valve to a bypass channel.

### SUMMARY OF THE INVENTION

In order to accomplish the above object, the inventors of the present invention have conducted extensive studies and have come to the idea of the present invention based on the findings that a low-temperature start-up system can be constructed at low cost using seawater that is present around the fuel cell watercraft, because the temperature of seawater only decreases to about 5° C. even when the air temperature is below the freezing point.

Specifically, the present invention relates to a control system for a fuel cell watercraft, the fuel cell watercraft including: a fuel cell module; an electric motor serving as a power source to generate propulsive force for a hull; a seawater line and a seawater pump for taking in seawater from outside of the hull; a coolant line and a coolant pump for circulation of coolant between a heat exchanger on the seawater line and the fuel cell module; and a battery adapted to be charged with electric power generated by the fuel cell module and to supply the electric power to the electric motor and the fuel cell module auxiliaries including the seawater pump and the coolant pump, wherein the control system is configured to execute a start-up routine including starting the seawater pump and the coolant pump at a time of start-up, stopping the seawater pump and starting the fuel cell module when coolant temperature reaches seawater temperature or more, and restarting the seawater pump when the coolant temperature reaches a steady-state operating temperature of the fuel cell module.

As described above, based on the knowledge that the temperature of seawater only decreases to about 5° C. even when air temperature is below the freezing point, the control system for a fuel cell watercraft according to the present invention starts the seawater pump and the coolant pump at the time of start-up, increases the coolant temperature through heat exchange with seawater, and stops the seawater pump and starts the fuel cell module when the coolant temperature reaches the seawater temperature or more. Therefore, even when the air temperature is below the freezing point, the control system can use seawater to increase the coolant temperature up to temperatures around 5° C., at which the fuel cell module can be started, and eliminate the need for a heater for low-temperature start-up and a switching valve to a bypass channel, so that a simple and inexpensive low-temperature start-up system can be constructed.

In addition, the control system for a fuel cell watercraft temporarily stops the seawater pump and starts the fuel cell module when the coolant temperature reaches the seawater temperature or more, and restarts the seawater pump when the coolant temperature reaches a steady-state operating temperature of the fuel cell module. Therefore, the control system for a fuel cell watercraft also has advantages of being able to reach a steady-state operating temperature sooner than when the seawater pump is continuously started and being able to minimize the operating time and power requirements of the seawater pump.

### BRIEF DESCRIPTION OF THE DRAWINGS

FIG. 1 is a plan view showing a fuel cell watercraft according to an embodiment of the present invention; and

FIG. 2 is a flowchart showing control of the fuel cell watercraft according to the embodiment of the present invention during low-temperature start-up.

### DETAILED DESCRIPTION

An embodiment of the present invention is described below in detail with reference to the drawings.

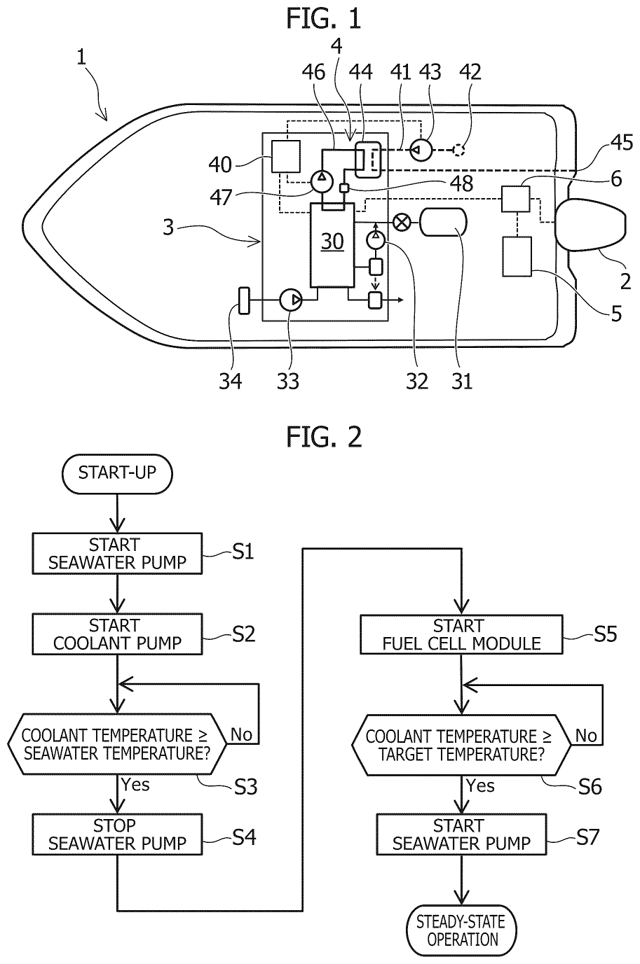

In FIG. 1, a fuel cell watercraft 1 according to the embodiment of the present invention includes an electric outboard motor 2 that includes a propeller and an electric motor for generating propulsive force for a hull, the electric outboard motor 2 being mounted on a rear portion 12 of the hull so that the fuel cell watercraft 1 is steerable. The fuel cell watercraft 1 also includes a fuel cell module 3 for generating electric power that is supplied to the electric outboard motor 2, and a cooling system 4 for the fuel cell module 3.

The fuel cell module 3 includes a fuel cell stack 30, hydrogen-based equipment such as a hydrogen fuel tank 31 and hydrogen circulation pump 32, and oxygen-based equipment such as an air filter 34 and a blower 33. The fuel cell module 3 constitutes a fuel cell system together with electrical equipment and a control unit 40, the electrical equipment including a battery 5 adapted to be charged with electric power generated by the fuel cell module 3 and to supply the electric power to the electric motor 2 and to an auxiliary machine of the fuel cell module 3, and a power converter 6.

The battery 5 preferably includes a main battery (such as a lithium-ion battery, LIB) for feeding electric power to a motor of the electric outboard motor 2, and a low-voltage battery for supplying electric power to auxiliary machines (the hydrogen circulation pump 32, the blower 33, a seawater pump 43, and a coolant pump 47) of the fuel cell module 3 and to the control unit 40. The power converter 6 may also include a step-down converter and a step-up converter.

The fuel cell stack 30 is formed by stacking a large number of unit cells each constituted of a membrane electrode assembly (MEA), a hydrogen-side separator stacked on one side of the MEA through a gas diffusion layer, and an air-side separator stacked on the other side of the MEA through another gas diffusion layer. A coolant channel is provided between each unit cell.

The cooling system 4 includes a seawater line 41 including the seawater pump 43 for pumping seawater taken in through an intake port 42 of a hull bottom portion to a heat exchanger 44 and draining the seawater through a drain port 45, and a coolant line 46 including the coolant pump 47 for circulation of coolant between the fuel cell module 3 (fuel cell stack 30) and the heat exchanger 44.

As described later, in order to execute a low-temperature start-up process using the cooling system 4, the heat exchanger 44 and the coolant line 46 are preferably covered with a heat insulating material so as to be insulated from ambient air. For the coolant in the coolant line 46, fresh water (pure water) with low electrical conductivity or antifreeze solution containing an antifreeze agent, such as ethylene glycol, may be used.

The coolant line 46 is equipped with a temperature sensor 48. Based on the coolant temperature detected by the temperature sensor 48, the control unit 40 determines a freezing state of product water in the fuel cell module 3, and also controls the coolant pump 47 and the seawater pump 43 to perform low-temperature start-up and cooling (temperature control) during steady-state operation.

FIG. 2 is a flowchart showing a low-temperature start-up routine of the fuel cell watercraft 1 including the cooling system 4 as described above. At the start-up of the fuel cell watercraft 1, when the temperature of the coolant detected by the temperature sensor 48 is less than a predetermined low temperature (for example, 5° C.), the seawater pump 43 is first started to take seawater into the seawater line 41 through the intake port 42 so that the seawater circulates to the heat exchanger 44 (S1).

Then, the coolant pump 47 is started so that the coolant in the coolant line 46 circulates between the fuel cell stack 30 and the heat exchanger 44 (S2). When the heat exchange with seawater in the heat exchanger 44 increases the coolant temperature, and the coolant temperature reaches the seawater temperature or more (Yes in S3), ice in the fuel cell module 3 is determined to be melted. Therefore, the seawater pump 43 is stopped (S4), and the fuel cell module 3 is started (S5).

Once the fuel cell module 3 is started, heat is generated at the same time as electric power is generated through an oxidation-reduction reaction between fuel hydrogen and oxygen in the air, and the coolant temperature rises as the temperature of the fuel cell stack 30 rises. Then, when the coolant temperature reaches a predetermined target temperature (for example, 60° C.) that corresponds to a steady-state operating temperature (Yes in S6), the seawater pump 43 is restarted (S7). After that, the fuel cell module 3 shifts to steady-state operation in which on-off control of the seawater pump 43 and the coolant pump 47 is performed so as to maintain the coolant temperature at a steady-state operating temperature (about 60° C. to 80° C.).

Executing the low-temperature start-up routine as described above can increase the coolant temperature up to the temperature at which the fuel cell module 3 can be started-up with the seawater having a temperature of 5° C. or more even when air temperature is below the freezing point, with use of the seawater line 41 that is originally used for cooling. This allows the heater in the coolant line 46 to be eliminated in models other than those designed for cold climates. Furthermore, the electric power used for the heater can also be reduced even in the specifications in which the coolant line 46 has a heater.

In the case in which, for example, the seawater temperature is less than a predetermined temperature (for example, 3° C.) at the time of start-up, the seawater pump 43 and the coolant pump 47 are first started, and then the seawater pump 43 is stopped and the heater of the coolant line 46 is started when the coolant temperature reaches the seawater temperature (for example, 3° C.). The heater is stopped when the coolant temperature reaches a second predetermined temperature or more after the fuel cell module 3 is started. As a result, use of the heater can be minimized by using a temperature difference between the seawater and the coolant.

In any mode of use, the coolant line 46 does not require a bypass line nor a three-way valve for switching to the bypass line, so that the system can be simplified. Even at temperatures below the freezing point, it is possible to shorten the time until the watercraft is permitted to depart, prevent deterioration of the membrane electrode assembly (MEA), and advantageously extend the life of the fuel cell system.

Although the embodiment of the present invention has been described in the foregoing, the present invention is not to be limited to the embodiment disclosed, and various modifications and changes are further possible within the scope of the present invention based on the technical ideas of the present invention.

What is claimed is:

1. A control system for a fuel cell watercraft, the fuel cell watercraft including: a fuel cell module; an electric motor serving as a power source to generate propulsive force for a hull; a seawater line and a seawater pump for taking in seawater from outside of the hull; a coolant line and a coolant pump for circulation of coolant between a heat exchanger on the seawater line and the fuel cell module; and a battery adapted to be charged with electric power generated by the fuel cell module and to supply the electric power to the electric motor and the fuel cell module auxiliaries including the seawater pump and the coolant pump,
wherein the control system is configured to execute a start-up routine including starting the seawater pump and the coolant pump at a time of start-up, stopping the seawater pump and starting the fuel cell module when coolant temperature reaches seawater temperature or more, and restarting the seawater pump when the coolant temperature reaches steady-state operating temperature of the fuel cell module.

2. The control system for a fuel cell watercraft according to claim 1, wherein in a case in which the seawater temperature is less than a first predetermined temperature at the time of start-up, the control system is configured to stop the seawater pump and start a heater of the coolant line when the coolant temperature reaches the seawater temperature or more, and to stop the heater when the coolant temperature reaches a second predetermined temperature or more.
